(19) United States
(12) Patent Application Publication
(10) Pub. No.: US 2010/0024650 A1
(43) Pub. Date: Feb. 4, 2010

(54) MICROTANKS FOR COMPRESSED GAS STORAGE AND METHODS FOR MAKING SAME

(75) Inventor: Xiangcun Long, Albuquerque, NM (US)

Correspondence Address: QXWAVE, INC., 10412 RIDGECIRCLE NW, ALBURQUERQUE, NM, 87114, US

(73) Assignee: QXWAVE INC., Albuquerque, NM (US)

(21) Appl. No.: 11/832,337

(22) Filed: Aug. 1, 2007

(51) Int. Cl. B01D 53/22

(52) U.S. Cl. 96/10; 428/364; 428/401

(57) ABSTRACT

Microtanks are formed in capped holey fibers. Holey fiber is composed of a shell, a porous layer and a hollow core. Compressed gas can be stored in plurality of microtanks at elevated pressure. A method of storing and releasing hydrogen gas in or out of a plurality of microtanks is also disclosed.

### FIELD OF THE INVENTION

This invention relates to a method to manufacture microtanks and a system to store compressed gas such as hydrogen with high safety.

### BACKGROUND OF THE INVENTION

There are numbers of hydrogen storage methods. These include liquid hydrogen at low temperature, compressed gaseous hydrogen in gas-cylinders, metal hydrides and chemical hydrides and physical-chemical absorbed hydrogen in carbon nanotubes. Some of these methods have moved from laboratory stage into prototype vehicles. Each of these options has advantages and disadvantages. Compressed gaseous and liquid hydrogen storage is most mature technology and commercially available.

Extensive active research and development efforts have been made to overcome technical barriers for hydrogen storage. The major barriers for hydrogen storage are low H₂ gravimetric and volumetric storage capacity, difficulty in storing and releasing H₂, high materials and system costs and safety.

In US Patent “Hydrogen supply method” (U.S. Pat. No. 4,211,537, Jul. 8, 1980), Teitel proposed storage of high-pressure hydrogen in glass microspheres as a solution to the problems inherent in hydrogen storage and transport. Hollow glass microspheres for storage of hydrogen gas onboard a vehicle involve charging, filling, and discharging. First, the hollow glass spheres are filled with H₂ at high pressure (350-700 bars) and high temperature (300° C.) by permeation in a high-pressure vessel. Next, the micro spheres are cooled down to room temperature and transferred to the low-pressure vehicle tank. Finally, the micro spheres are heated to 200-300° C. for controlled release of H₂ to run the vehicle. The microspheres generally have a diameter ranged from 5 microns to about 500 microns. The wall of the microspheres is generally from 1% to 10 % that of the microsphere diameter. Glass microspheres have the potential to be inherently safe as they store H₂ at a relatively low pressure onboard and are also suitable for conformable tanks. This allows for low container cost. It is demonstrated that storage density of hydrogen reaches to 5.4 wt. %. Theoretical calculations indicated that hydrogen storage capacity with over 40 wt % and liquid hydrogen density in super-high-strength microspheres is achievable. However, there are two technical challenges associated with the hollow microsphere hydrogen storage for practical applications: One is manufacture of high strength hollow microspheres; the other one is how to heat microspheres to promptly release stored hydrogen.

Shelby disclosed a technique to overcome the hydrogen release problem of hollow glass microspheres in US Patent “Glass membrane for controlled diffusion of gases” (U.S. Pat. No. 6,231,642, May 15, 2001). They found the stored hydrogen in glass microsphere could be instantly released upon irradiated by infrared (IR) light. The response time is less than 1 second compared to conventional furnace heating method where 10′s minutes need for hydrogen release. The out-gassing of H₂ was enhanced by absorption of light in Fe₃O₄ or NiO doped glasses. The H₂ release rate is proportional to lamp intensity above a threshold. The rapid response is essential for the microsphere storage when H₂ gas is required to be supplied on demand. However, it was found that only a portion of the hydrogen was released by photo-induction, possibly suggesting that this phenomenon occurred in the near surface of the glass. This partially release of hydrogen will be a main technical barrier prohibiting hollow glass microspheres from as hydrogen storage media.

It is an objective of present invention to disclose high strength holey fiber structures as compressed gas storage media with large storage capacity.

Another object of the present invention is that holey fibers function as light waveguides to deliver lights to heat up fibers for release of stored gas with instant response and controllable gas supply rate.

It is a further object of present invention that an new storage system for compressed gas provide safe, inexpensive and convenient solution to applications such as onboard fuel supply for on ground automobile vehicles, aircraft, spacecraft, and fuel cells for portable electronic devices.

### SUMMARY OF THE INVENTION

According to the invention, capped holey fibers are used to form microtanks. Holey fibers have shell and hollow or porous structures. Characteristic structures of holey fibers provide properties of high mechanical strength and large gas filling capacity and desired gas permeability. Diameters of holey fibers are ranged from 60 microns to 2000 microns. The thickness of shell is ranged from 1 micron to tens microns. The thickness of wall of porous structure is typically smaller than one micron. The aspect ration of porous structure is greater than 5. The materials of holey fibers have high tensile strength with value no less than 4 GPa. Preferably, synthetic fused silica is used as holey fiber materials.

Another embodiment of present invention is that plurality of microtanks are assembled in groups and aligned with same direction. Further, the grouped microtanks are packed in a vessel and aligned at same directions. In this manner, lights can be coupled into following groups and transmitted through.

Present invention also disclosed a method to fill, store and release of compressed gas in invented microtanks. Compressed gas is induced into microtanks by permeation in a vessel at elevated temperature and high pressure. The compressed gas is stored in plurality of microtanks at ambient temperature. The gas is released at controllable rate by illumination of lights on ends of microtanks.

### BRIEF DESCRIPTION OF THE DRAWINGS

A better understanding of the invention will obtained by reference to the detailed description below, in conjunction with the following drawings, in which:

FIG. 1 shows cross-sectional side views of a holey fiber geometry.

FIG. 2 shows cross-sectional side view of a microtube geometry.

FIG. 3 shows cross-sectional side view of a holey fiber with a coated metal film.

FIG. 4 shows cross-sectional side views of a closure microtank formed by a capped holey fiber

FIG. 5 shows a system setup for storage and supply of compressed gas.

### DETAILED DESCRIPTION OF THE INVENTION

Optical fibers produced with synthetic fused silica have remarkable strength. Based on the Si-O bond strength, the fiber has a theoretical strength of ˜2000 kpsi or 14 GPa, which is stronger than steel. In practice the observed strength is considerably lower (typically 700 kpsi or 5.5 GPa) due to the presence of small flaws in the bulk and on the surface of the silica.

The proof tensile strength of microstructured holey fiber is about 4.5 GPa, which is slightly lower than the one of standard silica fibers. This is partially because of lower fiber drawing temperature that is necessary to avoid collapse of glass walls of hollow fibers. This high tensile strength allows us to make super-strength-holey fibers.

In the case of simple spherical symmetry, a stretching stress is given by

σ=R_{b}P/2ΔR_{b}=PA_{b}/2

where P is the gas pressure, in a thin-walled shell with a radius of R_{b}, a thickness of ΔR_{b} and a aspect ratio A_{b}(A_{b}=/R_{b}ΔR_{b}). The created stretching stress, σ, should be lower than the stress of destruction, σ_{ι}, of the shell materials. This formula indicated that larger stress of destruction of shell materials is required if a geometry with larger aspect ration is used. On the other hand, it is preferred to use a geometry with larger aspect ratio for higher storage capacity. Mechanical strength and storage capacity require contrarily a aspect ration for a geometry of a vessel.

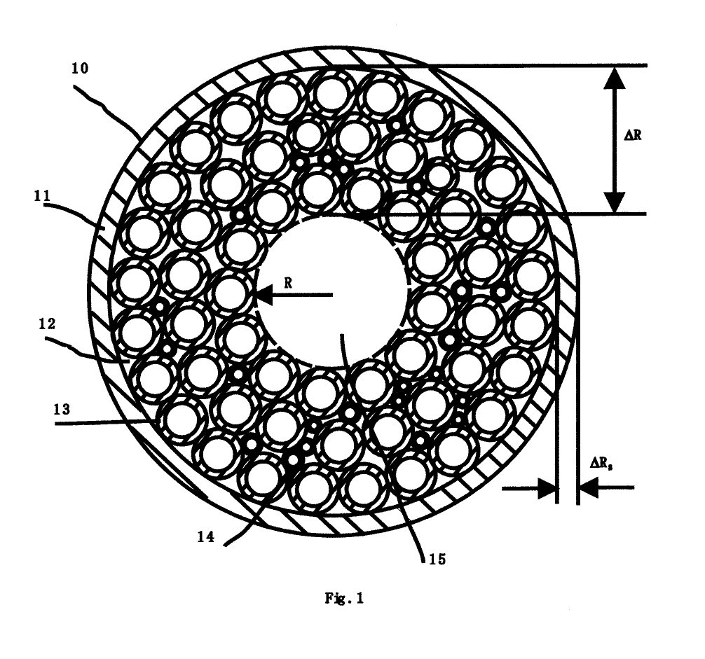

In accordance with the invention, referring to FIGS. 1-4, the holey fiber 10 have three characteristic structures with thin shell 11, porous layer 12 and hollow core 15. The holey fiber 10 has a round circle cross-section shape. The diameter, R+ΔR+ΔRₛ, of holey fibers 10 is ranged from 50 microns to 2000 microns. The invented holey fibers 10 possess high mechanical strength and large storage capacity. The materials for shell 11 and porous layer 12 are either transparent glasses or polymers or their combinations. One of preferred materials for high strength holey fibers is synthetic fused silica glasses.

A cross section view of holey fiber 10 is shown in FIG. 1. Shell 11 is used to adjust diffusion rate of compressed gas. The thickness of thin shell 11 is ΔRₛ, which is ranged from one micron to 50 microns. The thickness of porous structure 12 is ΔR. The radius of hollow core 15 is R. The aspect ration of porous layer 12 and hollow core 15 is A. The value of A is varied from zero up to 100. The hollow core disappears and holey fibers are filled with porous network when the aspect ration A is zero.

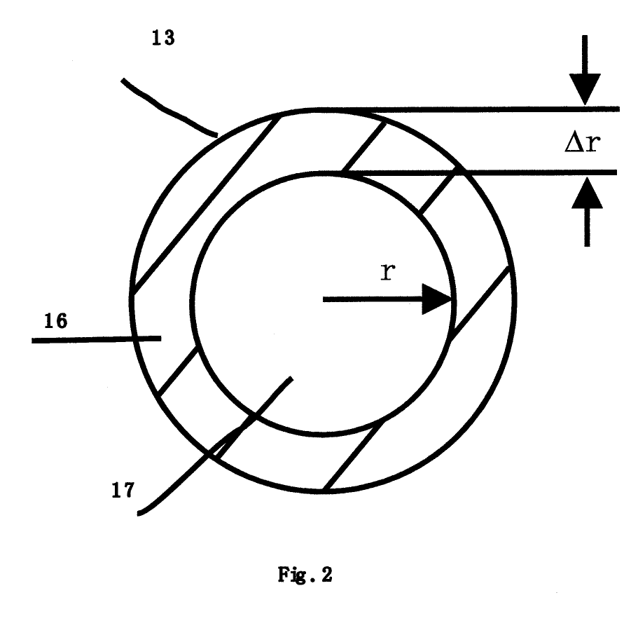

The porous layer 12 is composed of microtubes 13. The cross section shape of microtubes 13 can be a round circle, ellipse, rectangle, square, or polyhedron or their combinations. The cross section view of circle microtubes 13 is shown in FIG. 2. The radius of microtubes 13 is r and thickness of the wall is Δr. The aspect ratio of microtubes is B (B=r-Δr). The microtubes 13 are packed and fused together to form a porous network. Smaller microtubes 14 may be arranged between larger microtubes 13 to enhance connection of materials networks. The thickness of the wall of microtubes 13, Δr, is typically smaller than one micron. The aspect ration B is normally larger than 1. However, it should not larger than 50. The strength of holey fibers will mechanically become weak when the B value is too large.

Porosity of the holey fibers 10, ν, the ration of holes area to wall area, is given by formula

ν≅(A+2B/(B+2))/(A+2)

Porosity of holey fibers can exceed over ˜95% when aspect ratio A and B were properly selected to simultaneously achieve high mechanical strength of holey fibers and high storage capacity.

Stored hydrogen in cylinder microtanks will be diffused out through thin walls of fibers. The stored amount of hydrogen, A, after time, t, can be expressed as

A =A_{O}exp(−t/τ)

where A_{O} is initial stored hydrogen, τ is a characteristic time. τ is related to the radius of hollow core, R, the thickness of porous layer, ΔR, the thickness of shell, ΔRₛ, and wall materials permeability parameters K, by formula:

$$τ \approx \frac{( R + Δ R ) Δ {R}_{S}}{K}$$

The capability of filling shells and storing hydrogen is based on the fact that for the majority of materials the gas permeabilities rapidly increased with temperature according to formula:

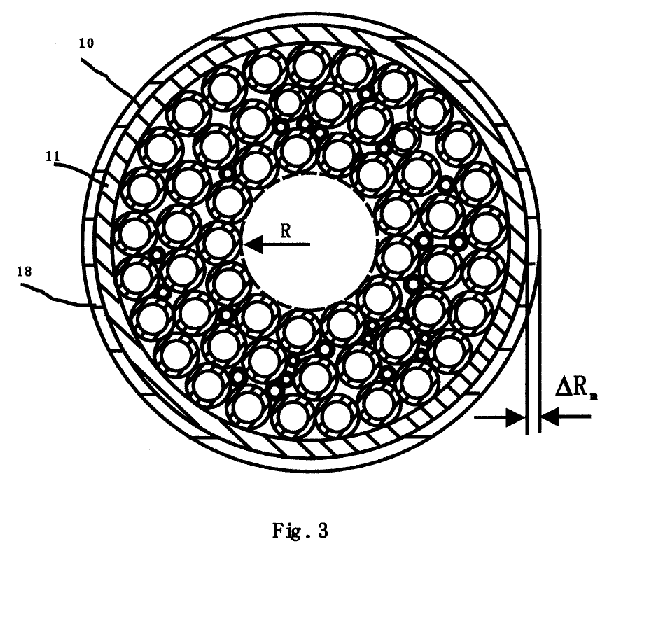

K=K₀ exp(−Eₖ/kT)

where k is the Boltzman constant and Eₖ is the activation energy. For the fused silica, the parameter k is ranged between 0.007 and 0.1×10⁻¹⁰cm²atm⁻¹s⁻¹. Obviously, the storage time and release time of stored hydrogen can be controlled by geometry of microtanks, temperature or materials properties. The k value of metal material is at least three orders lower than the one of silica glass materials. A very thin metal film 18, as shown in FIG. 3, with thickness, ΔRₘ, of less than 100 nm such as Ti can be coated on surface of fibers 10 to enhance storage time at ambient temperature if necessary. Coated thin metal film is also used to enhance the absorption of IR light for heating the shells of holey fibers.

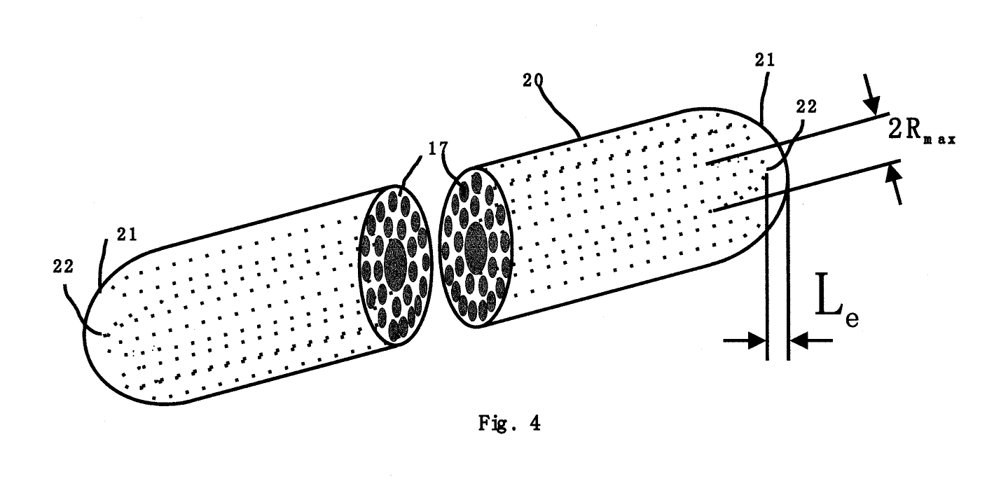

Both ends 21 of holey fibers are capped to form closure microtanks 20. The capped end of holey fibers is shown in FIG. 4. The thickness of capped end wall 22, Lₑ, of holey fibers should be large enough to sure that the ratio of radius, Rₘₐₓ, of largest microtubes 17 to the thickness of capped end wall 22 is smaller than one. Preferred shape of capped ends of holey fibers is a hemisphere. The length of capped holey fibers 20 can be varied from millimeters to meters.

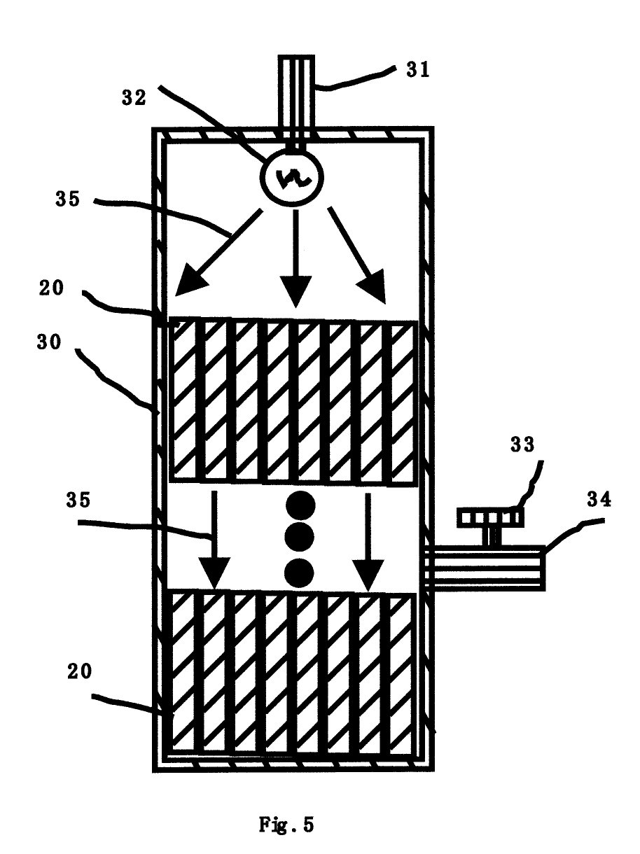

The hydrogen storage system is shown in FIG. 5. It is composed of a low pressure vessel 30, plurality of high strength microtanks 20 stored with high pressure hydrogen and a light source 32 for heating purpose. Plurality of microtanks 20 are roughly aligned with one direction in groups. Lights 35 form light source 32 are coupled into microtanks and can be coupled following group of microtanks to allow light to reach all of fibers. The microtanks are heated near to the glass transition temperature, T_{g}, of microtanks material. The compressed gas stored in microtanks 20 was diffused out with instant response. The gas conduit 34 with a valve 33 installed in vessel 30 is used to connect gas supply to external devices such as fuel cells or gas engines.

What is claimed is:

1. A holey fiber comprising a shell, a porous layer and a hollow core.

2. Holey fiber in claim 1, wherein said shell, said porous layer are comprised of transparent materials with such as glasses or polymers or their combination with desired tensile strength.

3. Holey fiber in claim 1, wherein said diameter, R+ΔR +ΔRₛ, of holey fibers is ranged from 50 microns to 2000 microns.

4. Holey fiber in claim 1, wherein said shell thickness is ranged from 1 micron to 50 microns.

5. Holey fiber in claim 1, wherein said cross section shapes of said microtubes are round circle, ellipse, rectangle, square, or polyhedron or their combinations.

6. Holey fiber in claim 1, wherein said porous layer were formed by microtubes with aspect ratio B ranged from 1 to 50.

7. Holey fiber in claim 1, wherein said thickness of said microtubes is less than 1 micron.

8. Holey fiber in claim 1, wherein aspect ratio A of said porous layer and said hollow core is ranged from zero to 100.

9. Holey fiber in claim 1, wherein porosity of said holey fibers, ν, is given by formula
v≅(A+2B/(B+2))/(A+2).

10. Holey fiber in claim 1, wherein said shell was coated with a metal film to adjust diffusion rate of compressed gas and also enhance absorption of lights in said holey fibers.

11. Holey fiber in claim 1, wherein said both ends of said holey fiber were capped to form a closure microtank with the thickness of end wall exceeding over the maximum radius of microtubes and length of microtanks varied from millimeters to meters.

12. A vessel containing gas conduit, a plurality of said microtanks in claim 10, wherein said microtanks are assembled in groups with same direction and said groups of microtanks are aligned to one direction to permit that lights can be coupled into following groups of said microtanks.

13. The ends of said grouped microtanks pre-filled with compressed gas in claim 11, wherein said lights form said light source illuminate said ends of said grouped microtanks to heat said shell of said holey fibers near to said glass transition temperature, T_{g}, of said microtanks material to release stored compressed gas out of said microtanks.
